(19) United States
(12) Patent Application Publication
(10) Pub. No.: US 2025/0013921 A1
(43) Pub. Date: Jan. 9, 2025

(54) SOURCE SELECTION USING QUALITY OF MODEL WEIGHTS

(71) Applicant: Telefonaktiebolaget LM Ericsson (publ), Stockholm (SE)

(72) Inventors: Farnaz Moradi, Bromma (SE); Andreas Johnsson, Uppsala (SE); Jalil Taghia, Stockholm (SE); Hannes Larsson, Solna (SE); Masoumeh Ebrahimi, Solna (SE); Xiaoyu Lan, Täby (SE)

(73) Assignee: Telefonaktiebolaget LM Ericsson (publ), Stockholm (SE)

(21) Appl. No.: 18/712,011

(22) PCT Filed: Feb. 18, 2022
(86) PCT No.: PCT/EP2022/054120

§ 371 Date: May 21, 2024

(51) Int. Cl. G06N 20/00

(52) U.S. Cl. CPC G06N 20/00

(57) ABSTRACT

Methods and systems for source machine learning (ML) model selection for the transfer learning. A method may include receiving a source ML model request from a target domain, determining candidate source ML models, calculating a model quality score for each of the candidate source ML models, using the calculated model quality scores to select candidate source ML models, sending the selected candidate source ML models to the target domain, receiving fine-tuned ML model weights for fine-tuned ML models, and calculating a model quality score for each of the fine-tuned ML models. The method may include determining, for each of the fine-tuned ML models, a ranking and/or a deployment recommendation for the fine-tuned ML model based on the model quality score for the fine-tuned ML model and sending, for each of the fine-tuned ML models, the ranking and/or the deployment recommendation for the fine-tuned ML model to the target domain.

### TECHNICAL FIELD

This disclosure relates to source machine learning (ML) model selection for the transfer learning.

### BACKGROUND

Transfer learning (TL) is a data efficient method. In TL, pre-trained Machine Learning (ML) models are transferred and fine-tuned (e.g., re-trained and/or updating one or model weights/parameters) in a target domain to achieve better performance, faster training, lower computational cost, and/or consequently lower energy consumption in a target task. The number of available pre-trained models (also known as source models) has increased. With the increase in the number of available pre-trained models, the selection of the most beneficial source model has become a challenge. Fine-tuning and evaluating all existing source models is inefficient and/or computationally unacceptable. Furthermore, after fine-tuning the model, the evaluation of the performance of the transferred model can be challenging if only limited data samples are available in the target domain. Ideally, one would like to use all the samples in target for fine-tuning rather than testing and evaluation.

### Transfer Learning (TL)

Transfer learning has been widely used in computer vision (CV) and natural language processing (NLP). Transfer learning has also been shown to be beneficial in other domains, such as telecommunications.

The transfer learning problem is defined as follows. Given a source domain DS, a learning task TS, a target domain DT, and a learning task TT, transfer learning aims to help improve the learning of the target predictive function fT(⋅) in DT using the knowledge in DS and TS, where DS≠DT and/or TS≠TT.

Transfer learning is specifically beneficial in scenarios where not enough data samples are available in the target and/or data collection is expensive or time consuming. In such cases, the limited number of target samples are extremely valuable for fine-tuning the source model, and, therefore, a proper evaluation of the fine-tuned model in the target domain with a hold-out test set would not be desired.

### Source Selection

A variety of studies have looked into the importance of source selection. It is known that a poorly selected source model can even lead to negative transfer, which means that training a model with limited samples in the target can outperform a pre-trained and fine-tuned source model.

In the literature, there are two widely used approaches to source model selection: (1) task-agnostic model selection and (2) task-aware source selection. Task-agnostic model selection methods aim at ranking models without using target data. A popular strategy is to pick (a) the best performing source model (e.g., based on its accuracy on source data), (b) the source model that was trained on the largest dataset, or (c) the source model with the highest number of parameters. It has been observed that such task-agnostic methods based on performance, dataset size, or number of parameters fail to rank the source models on their own. See Cedric Renggli and André Susano Pinto and Luka Rimanic and Joan Puigcerver and Carlos Riquelme and Ce Zhang and Mario Lucic, “Which Model to Transfer? Finding the Needle in the Growing Haystack”, arXiv: 2010.06402, 2020. Alternatively, diversity-based source selection techniques seek for the most diverse source, such as the most complex source (e.g., in terms of entropy), under the assumption that, if there are a sufficient number of samples in source domains, one can robustly measure diversity of the source domains.

Task-aware source selection methods use the data from the target task. An example is similarity based methods which seek for the source domain that is most similar to the target domain. Such methods have inherent limitations in particular when there are limited samples in the target domain. This is due to the difficulties in robustly computing the similarity measures from a limited pool of data samples. Moreover, it has been observed that task-aware methods perform significantly worse on structured datasets compared to natural datasets. See Cedric Renggli and André Susano Pinto and Luka Rimanic and Joan Puigcerver and Carlos Riquelme and Ce Zhang and Mario Lucic, “Which Model to Transfer? Finding the Needle in the Growing Haystack”, arXiv: 2010.06402, 2020.

Another challenge that can exist for source model selection is that the source data used for training the source models might not be available, for example, due to privacy concerns (e.g., due to General Data Protection Regulation (GDPR) or other legislations) or due to the high cost of data transmission. Therefore, calculating the diversity of the source data or the similarity between source and target data may not be possible. However, the model weights and architecture can still be made available. In some cases, even the performance of the source model might be unknown or difficult to validate due to lack of access to the source test data.

### Neural Network Model Weights

Model parameters, particularly the weights of neural network models, have shown to carry knowledge that can be shared and transferred among different domains. In transfer learning, weights of models that are pre-trained on data from one domain can be transferred to improve the model performance and speed up model training in different domains and even for different tasks.

In de-centralized learning methods, such as federated learning, the agents share their model weights with a server which then aggregates them and sends back to the agents for improved model performance while preserving data privacy.

Research has looked into obtaining deeper understanding of what knowledge is hidden in model weights, particularly neural network models. The main goal of such studies is to gain insights about neural network training and generalization. For example, in Thomas Unterthiner and Daniel Keysers and Sylvain Gelly and Olivier Bousquet and Ilya Tolstikhin, “Predicting Neural Network Accuracy from Weights, arXiv: 2002.11448, 2020 (hereafter “Reference 1”), the authors show that is possible to predict the performance of a Deep Neural Network (DNN) using only its weights (or simple statistics thereof) as inputs. This paper has investigated different image datasets and model architectures and has shown a model can be trained using Convolutional Neural Networks (CNN) model weights to predict the accuracy of the model. The authors have also studied transfer to new architectures and datasets and showed that these predictions can still rank networks trained on unobserved natural image datasets/with different large architectures. See also U.S. Patent Application Publication No. 2021/0256422A1.

In Martin, Charles H. and Peng, Tongsu and Mahoney, Michael W., “Predicting trends in the quality of state-of-the-art neural networks without access to training or testing data”, in Nature Communications, 2021 (hereafter “Reference 2”), the authors look into predicting trends in the quality of state-of-the-art neural networks without access to training or testing data, by only investigating model weights. They perform a detailed empirical analysis to evaluate the quality metrics for publicly available pre-trained DNN models. They show that Power Law-based metrics are good at predicting quality trends in well-trained CV/NLP models and discriminating well-trained versus poorly trained models.

In Gabriel Eilertsen and Daniel Jönsson and Timo Ropinski and Jonas Unger and Anders Ynnerman, “Classifying the classifier: dissecting the weight space of neural networks”, arXiv: 2002.05688, 2020, the authors looked into dissecting the weight space of neural networks and showed that a small subset of consecutive weights can reveal a lot of information about the training setup of a network and its hyperparameters. In this paper, initialization is pinpointed as one of the most fundamental local features of the weight space, followed by activation function and optimizer.

In Yasunori Yamada, Tetsuro Morimura, “Weight Features for Predicting Future Model Performance of Deep Neural Networks”, in Proceedings of the Twenty-Fifth International Joint Conference on Artificial Intelligence (IJCAI-16), 2016 (hereafter “Reference 3”), the authors show how features extracted from model weights can be used to predict the final performance of the model being trained to terminate underperforming runs during hyperparameter search. See also U.S. Pat. No. 11,093,826 B2.

### SUMMARY

Existing solutions for source selection in transfer learning (TL) require access or knowledge of the source datasets. For example, similarity-based approaches require data in both source and target to calculate a similarity metric between the domains and perform poorly when the available data samples in the target are limited. Moreover, these approaches require heavy processing at real-time to calculate similarities to all available source domains and select a proper source domain to transfer, which imposes extensive time and computation overhead. For another example, diversity-based methods are suitable for scenarios where no or limited samples are available at the target. However, diversity-based methods need access to the data in the source domain to calculate the diversity (e.g., using entropy). The source data used for training the source models might not be available though, for example, due to privacy concerns (e.g., due to General Data Protection Regulation (GDPR) or other legislations) or the high cost of data transmission. Other task-agnostic methods typically require information about the test accuracies on the source test dataset as well as information about the size of the training dataset in the source domain.

In addition, the existing solutions that looked into using model weights to gain insight into neural network model performance do not perform source selection using fine-tuned models with limited number of samples and requirements for model deployment and resource constraints in the target domain.

Aspects of the invention may overcome one or more of the problems with the existing solutions for source selection in TL. Aspects of the invention may provide an automated source machine learning-model selection method for transfer learning. One of the applications of the invention may be, for examples, telecommunication systems. Aspects of the invention may take into account the model-weight statistics of the fine-tuned models and/or measurements from the target execution environment to select the best source model while reducing the need for excessive data collection for model evaluation in the target domain.

Aspects of the invention may provide a method for selection of a machine learning (ML) model in transfer learning setting. The method may include receiving a set of selected and/or generated candidate source models and corresponding fine-tuned transferred models. The method may include calculating and assigning a quality score to each of the candidate source models and their corresponding fine-tuned transferred models. The method may include ranking the source models and corresponding fine-tuned transferred models according to the assigned quality score. The method may include providing a list of ranked models.

In some aspects, the calculation of the quality score may be determined from one or more statistical features obtained from ML model parameters, changes in model parameters after re-training, model meta-data such as accuracy on source dataset, and/or monitored data from execution environment.

Aspects of the invention may provide advantages with respect to privacy, data collection cost, and/or reusability of previously tuned models. With respect to privacy, aspects of the invention may provide the advantage of the target not needing to share any raw data with the model manager. That is, in some aspects, the target may send only the updated model weights as well as requirements from its execution environment. With respect to privacy, aspects of the invention may additionally or alternatively provide the advantage of the model manager not needing access to the train and test data or the training process of the different source models but still being able provide a ranking of their performance based on model weights and the similarity of the tasks with the target domain. With respect to data collection cost, aspects of the invention may provide the advantage of reducing data collection cost in the target because no test data (or only limited test data) is required for evaluation of the transferred models. With respect to reusability of previously tuned models, aspects of the invention may provide the advantage of the ability for the previously trained source models to be used for future problems, without the need to maintain the data on which they have been trained or tested.

One aspect of the invention may provide a method a computer-implemented method performed by a machine learning (ML) model manager. The method may include receiving a source ML model request from a target domain. The method may include determining candidate source ML models, and the candidate source ML models may be pre-trained ML models. The method may include using model quality scores calculated for each of the candidate source ML models to select one or more of the candidate source ML models. The method may include sending the one or more selected candidate source ML models to the target domain. The method may include receiving fine-tuned ML model weights for one or more fine-tuned ML models (e.g., fine-tuned ML model weights for the one or more selected candidate source ML models). The method may include calculating a model quality score for each of the one or more fine-tuned ML models. The method may include determining, for each of the one or more fine-tuned ML models, a ranking and/or a deployment recommendation for the fine-tuned ML model based on the model quality score for the fine-tuned ML model. The method may include sending, for each of the one or more fine-tuned ML models, the ranking and/or the deployment recommendation for the fine-tuned ML model to the target domain.

In some aspects, the source ML model request may include information about a task, information about one or more input features, and/or one or more requirements. In some aspects, the source ML model request may include one or more requirements, and the one or more requirements may include a maximum model size, a required performance, and/or inference time requirements. In some aspects, the source ML model request may include a number of candidate source ML models for the model manager to select, and using the model quality score to select one or more of the candidate source ML models may include selecting the number of candidate source ML models.

In some aspects, determining the candidate source ML models may include selecting one or more existing source ML models from a model store. In some aspects, determining the candidate source ML models may include selecting one or more existing source ML models from a model store based on information about a task, information about one or more input features, and/or one or more requirements included in the source ML model request.

In some aspects, determining the candidate source ML models may include creating one or more new source ML models. In some aspects, creating the one or more new source ML models may include updating one or more existing source ML models from a model store. In some aspects, updating the one or more existing source ML models may include replacing neurons and/or layers of neural networks of the one or more existing source ML models with random weights and/or adding or removing neurons and/or layers to or from the one or more existing source ML models. In some aspects, for each of the one or more updated source ML models, a model quality score for the updated source ML model may be improved relative to a model quality score for an existing source ML model on which the updated source ML model is based.

In some aspects, determining the candidate source ML models may further include determining that no existing source ML models or an insufficient number of existing source ML models from a model store match information about a task, information about one or more input features, and/or one or more requirements included in the source ML model request. In some aspects, creating the one or more new source ML models may include: creating new source ML models; calculating a model quality score for each of the new source ML models; and/or using the model quality score calculated for the new source ML models to select one or more of the new source ML models. In some aspects, the one or more new source ML models may be created using parameters of one or more existing source ML models from a model store. In some aspects, creating the one or more new source ML models may include using one or more generative ML methods.

In some aspects, the model quality score for each of the candidate source ML models may be calculated using a predictive model to predict the performance of a candidate source ML model using parameters of the candidate source ML model, model quality, and/or metadata about the candidate source ML model (e.g., source dataset, execution time, and/or size). In some aspects, the model quality score for each of the candidate source ML models may be calculated based on (i) a model accuracy prediction (Acc) that predicts accuracy using parameters of a candidate source ML model, (ii) one or more model quality metrics (Quality) calculated using parameters of the candidate source ML model, (iii) a model inference cost (Cost) indicative of inference time and/or computation cost for the candidate source ML model, and/or (iv) model metadata (Meta) related to diversity of source data and/or accuracy on source test data). In some aspects, the model quality score for a candidate source ML model Msrc with a weight vector Wsrc may be a weighted sum:

$$Score ( {M}_{src} ) = {w}_{1} ( {W}_{src} ) + {w}_{2} ( {W}_{src} ) + {w}_{3} ( 1 - Cost ( {M}_{src} ) ) + {w}_{4} Meta ( {M}_{src} ) + c$$

where Σwᵢ=1, c is a constant, and all values are normalized.

In some aspects, calculating the model quality score for each of the one or more fine-tuned ML models may include using a predictive model to predict the performance of a fine-tuned ML model using weights of the fine-tuned ML model, model quality, changes in weights of the fine-tuned ML model relative to weights of a source ML model on which the fine-tuned ML model is based, and/or metadata about the fine-tuned ML model (e.g., source dataset, execution time, and/or size). In some aspects, the model quality score for each of the one or more fine-tuned ML models may be based on model accuracy prediction, model quality, changes in weights of the fine-tuned ML model relative to weights of a source ML model on which the fine-tuned ML model is based, and/or inference cost.

In some aspects, calculating the model quality score for each of the one or more fine-tuned ML models may be based on (i) a model accuracy prediction (Acc) that predicts accuracy using weights of a fine-tuned ML model, (ii) one or more model quality metrics (Quality) calculated using weights of the fine-tuned ML model, (iii) model weight changes (Distance) indicative of how much weights of the model have changed during fine-tuning, (iv) a model inference cost (Cost) indicative of inference time and/or computation cost for the fine-tuned ML model, and/or (iv) model metadata (Meta) related to diversity of source data and/or accuracy on source test data). In some aspects, the model quality score for a fine-tuned ML model Mft with a weight vector Wsrc based on a candidate source ML model Msrc with a weight vector Wsrc may be a weighted sum:

$$Score ( {M}_{src} ) = {w}_{1} ( {W}_{src} ) + {w}_{2} ( {W}_{src} ) + {w}_{3} ( 1 - Cost ( {M}_{src} ) ) + {w}_{4} Meta ( {M}_{src} ) + c$$

where Σwᵢ=1, c is a constant, and all values are normalized.

In some aspects, the method may further include: receiving feedback from the target domain identifying a deployed fine-tuned ML model; and adding the deployed fine-tuned ML model and/or metadata for the deployed fine-tuned ML model to a model store. In some aspects, the method may further include: receiving a target model trained solely using data samples in a target dataset of the target domain; calculating a model quality score for the target model; determining a ranking for the target model based on the model quality score for the target model; and/or sending the ranking for the target model to the target domain.

In some aspects, each of the one or more selected candidate source ML models may be pre-trained using data for a network service in an execution environment with a workload, and the one or more fine-tuned ML models may be the one or more selected candidate source ML models after being fine-tuned for a different network service, a different execution environment, and/or a different workload. In some aspects, each of the one or more selected candidate source ML models may be pre-trained using data for an Internet of things (IoT) device in an environment, and the one or more fine-tuned ML models may be the one or more selected candidate source ML models after being fine-tuned for a different IoT device and/or a different environment. In some aspects, the candidate source ML models may be for network performance prediction, key performance indicator (KPI) prediction, base station energy consumption prediction, Internet of things (IoT) traffic pattern classification, or manufacturing product quality inspection.

Another aspect of the invention may provide a machine learning (ML) model manager. The ML model manager may be configured to receive a source ML model request from a target domain. The ML model manager may be configured to determine candidate source ML models, and the candidate source ML models may be pre-trained ML models. The ML model manager may be configured to use model quality scores calculated for each of the candidate source ML models to select one or more of the candidate source ML models. The ML model manager may be configured to send the one or more selected source ML models to the target domain. The ML model manager may be configured to receive fine-tuned ML model weights for one or more fine-tuned ML models (e.g., fine-tuned ML model weights for the one or more selected candidate source ML models). The ML model manager may be configured to calculating a model quality score for each of the one or more fine-tuned ML models. The ML model manager may be configured to determining, for each of the one or more fine-tuned ML models, a ranking and/or a deployment recommendation for the fine-tuned ML model based on the model quality score for the fine-tuned ML model. The ML model manager may be configured to sending, for each of the one or more fine-tuned ML models, the ranking and/or the deployment recommendation for the fine-tuned ML model to the target domain.

Still another aspect of the invention may provide a computer-implemented method performed by a target domain. The method may include sending a source machine learning (ML) model request to a model manager. The method may include receiving one or more source ML models from the model manager, and the one or more source ML models may be one or more pre-trained ML models. The method may include determining one or more fine-tuned ML models by re-training the one or more source ML models with data samples in a target dataset. The method may include sending weights of the one or more fine-tuned ML models to the model manager. The method may include receiving a ranking and/or a deployment recommendation for each of the one or more fine-tuned ML models. The method may include using the ranking and/or the deployment recommendation for each of the one or more fine-tuned ML models to select a fine-tuned ML model. The method may include deploying the selected fine-tuned ML model.

In some aspects, the source ML model request may include information about a task, information about one or more input features, and/or one or more requirements. In some aspects, the source ML model request may include one or more requirements, and the one or more requirements may include a maximum model size, a required performance, and/or inference time requirements. In some aspects, the source ML model request may include a number of source ML models for the model manager to select, and receiving the one or more source ML models may include receiving the number of candidate source ML models.

In some aspects, deploying the selected fine-tuned ML model may include using the selected fine-tuned ML model for network performance prediction, key performance indicator (KPI) prediction, base station energy consumption prediction, Internet of things (IoT) traffic pattern classification, or manufacturing product quality inspection.

In some aspects, the method may further include receiving, for each of the one or more source ML models, information about a task and/or input features of the source ML model. In some aspects, the method may further include requesting monitoring information from an infrastructure monitor and sending the monitoring information to the model manager. In some aspects, the method may further include using test samples from a target dataset to calculate model performance for the one or more fine-tuned ML models. In some aspects, the method may further include sending a target model trained solely using data samples in a target dataset to the model manager. In some aspects, the method may further include sending feedback to the model manager identifying the deployed fine-tuned ML model.

In some aspects, each of the one or more source ML models may be pre-trained using data for a network service in an execution environment with a workload, and the one or more fine-tuned ML models may be the one or more source ML models after being fine-tuned for a different network service, a different execution environment, and/or a different workload. In some aspects, each of the one or more source ML models may be pre-trained using data for an Internet of things (IoT) device in an environment, and the one or more fine-tuned ML models may be the one or more source ML models after being fine-tuned for a different IoT device and/or a different environment.

Yet another aspect of the invention may provide a target domain. The target domain may be configured to send a source machine learning (ML) model request to a model manager. The target domain may be configured to receive one or more source ML models from the model manager, and the one or more source ML models may be one or more pre-trained ML models. The target domain may be configured to determine one or more fine-tuned ML models by re-training the one or more source ML models with data samples in a target dataset. The target domain may be configured to send weights of the one or more fine-tuned ML models to the model manager. The target domain may be configured to receive a ranking and/or a deployment recommendation for each of the one or more fine-tuned ML models. The target domain may be configured to use the ranking and/or the deployment recommendation for each of the one or more fine-tuned ML models to select a fine-tuned ML model. The target domain may be configured to deploy the selected fine-tuned ML model.

Still another aspect of the invention may provide a computer program comprising instructions for adapting an apparatus to perform the method of any one of the aspects above. Yet another aspect of the invention may provide a carrier containing the computer program, and the carrier may be one of an electronic signal, optical signal, radio signal, or compute readable storage medium.

Yet another aspect of the invention may provide an apparatus. The apparatus may include processing circuitry and a memory. The memory may contain instructions executable by the processing circuitry, whereby the apparatus is operative to perform the method of any one of the aspects above.

Still another aspect of the invention may provide an apparatus adapted to perform the method of any one of the aspects above.

Yet another aspect of the invention may provide any combination of the aspects set forth above.

### BRIEF DESCRIPTION OF THE DRAWINGS

The accompanying drawings, which are incorporated herein and form part of the specification, illustrate various aspects.

FIG. 1 illustrates a system including a model manager and a target domain according to some aspects.

FIGS. 2A and 2B are flowcharts illustrating a process according to some aspects.

FIG. 3 is a flowchart illustrating a process according to some aspects.

FIG. 4 is a sequence diagram illustrating a process according to some aspects.

FIG. 5 illustrates an example of source models created by a source model manager of a model manager for heterogeneous transfer learning according to some aspects.

FIG. 6 is a flowchart illustrating a process according to some aspects.

FIG. 7 is a flowchart illustrating a process according to some aspects.

FIG. 8 is a block diagram illustrating an apparatus according to some aspects.

FIGS. 9A and 9B are evaluation results according to some aspects.

### DETAILED DESCRIPTION

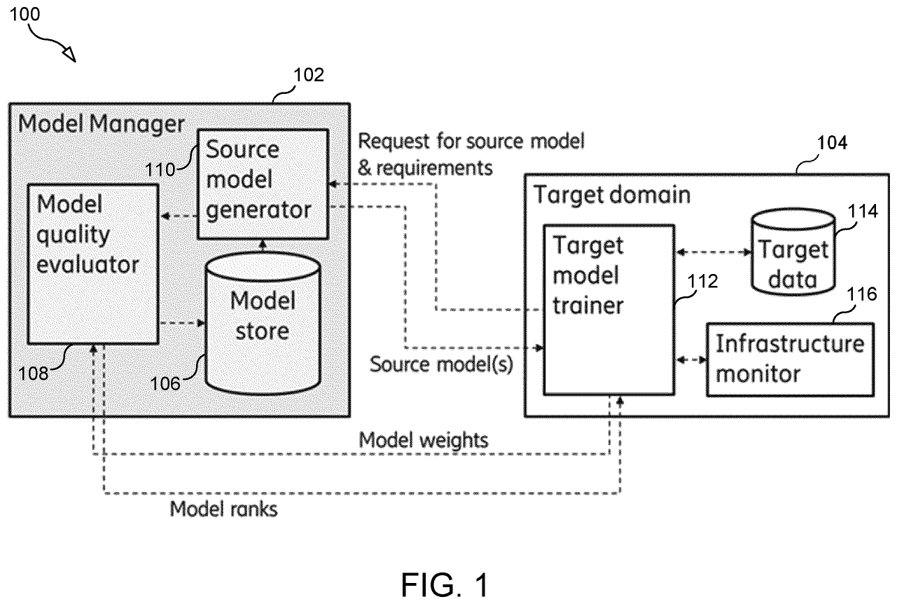

FIG. 1 illustrates a system 100 according to some aspects. As shown in FIG. 1, in some aspects, the system 100 may include a machine learning (ML) model manager 102 and a target domain 104.

In some aspects, the ML model manager 102 may include a model store 106, a model quality evaluator 108, and/or a source model generator 110. In some aspects, the model store 106 may be a database storing pre-trained (source) model weights. In some aspects, for each ML model, if metadata about the application (e.g., when the model was trained/re-trained, accuracy score, etc.) is available for the ML model, the metadata about the application may be stored in the model store 106. In some aspects, applications for the ML models may be, for example and without limitation, network performance prediction, key performance indicator (KPI) prediction, base station energy consumption prediction, Internet of things (IoT) traffic pattern classification, or manufacturing product quality inspection.

In some aspects, the model quality evaluator 108 may be an artificial intelligence (AI) and/or machine learning (ML) (AI/ML) based component. In some aspects, the model quality evaluator 108 may be configured to assign a quality score to the ML models stored in the model store 106 and/or ML models (e.g., fine-tuned models) received from target domain 104 using their weights and/or other data/metadata if available (e.g., diversity of the source dataset, performance on the source test data, and/or performance on other target test data sets).

In some aspects, the source model generator 110 may be configured to generate a source ML model from the top most relevant source models for a given target model. In some aspects, the source model generator 110 may generate the source ML model using the quality metadata in the model store 106 (e.g., quality data added by the model quality evaluator 108). In some aspects, the source model generator 110 may generate the source ML model additionally or alternatively using the other requirements from the target domain 104 such as, for example and without limitation, available input features, model size, and/or latency for inference. In some aspects, the source model generator 110 may be a source model selector. In some alternative aspects, the source model generator 110 may be a generative model which generates an augmented source from a list of source models such that the resulting source is the most relevant source to the target ML model.

In some aspects, the target domain 104 may include a target model trainer 112, a target dataset 114, and/or an infrastructure monitor 116. In some aspects, the target model trainer 112 may fine-tune the source ML models (e.g., received from the source model generator 110 of the model manager 102) using data samples in the target dataset 114, send updated model weights to the model manager 102 (e.g., to the model quality evaluator 108 of the model manager 102), and receive the quality scores/ranked list of ML models (e.g., from the model quality evaluator 108 of the model manager 102). In some aspects, the infrastructure monitor 116 may collect information about model execution from the system 100 (e.g., execution time).

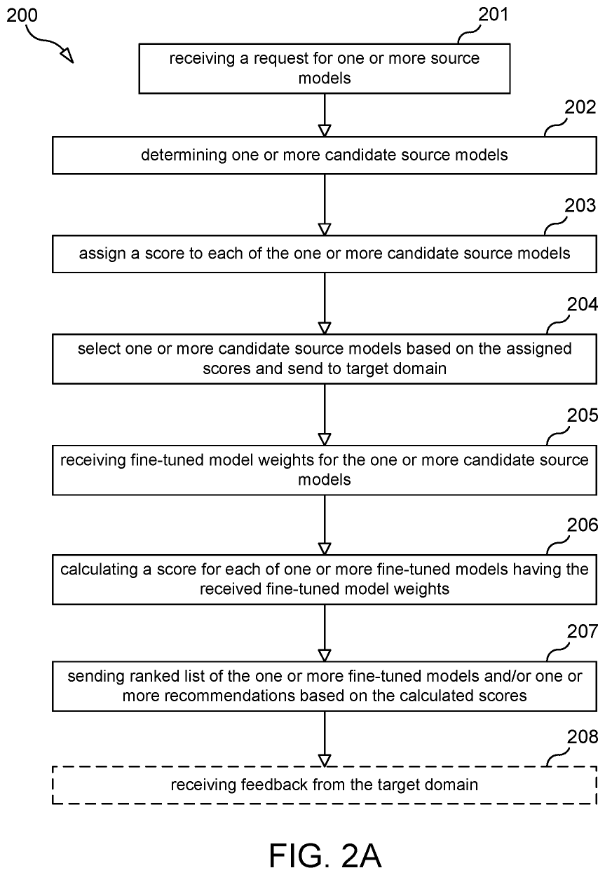

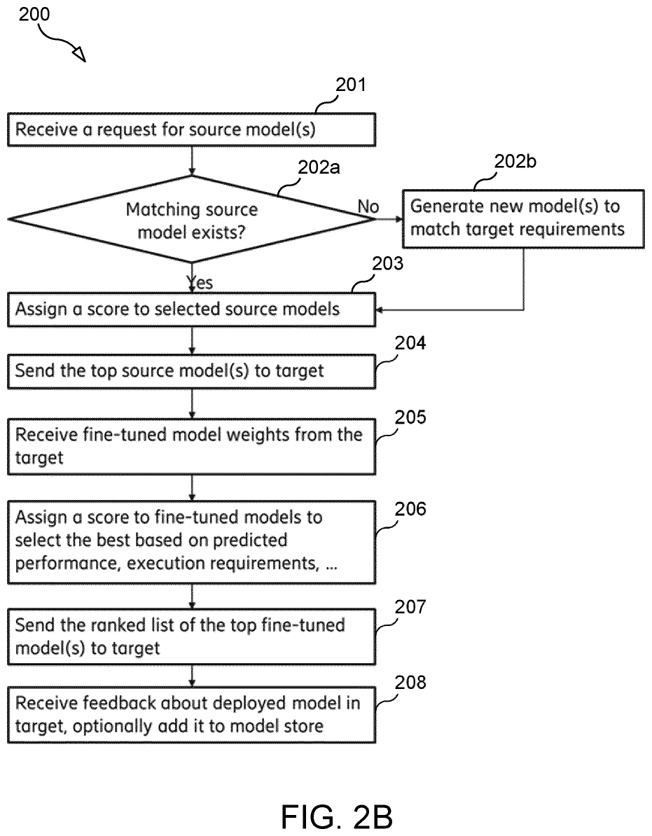

FIGS. 2A and 2B illustrate a process 200 that may be performed by the model manager 102 according to some aspects. In some aspects, the process 200 may include a step 201 in which the model manager 102 receives a request for one or more source ML models for a task. In some aspects, the request may include information about the task (T_T) and/or the input features (X_T). In some aspects, the request may include one or more requirements of the requested one or more source ML models. For example, in some aspects, the one or more requirements may include, for example and without limitation, the maximum model size, the required performance, and/or the inference time requirements. In some aspects, the request may additionally or alternatively include a maximum number and/or a minimum number (e.g., budget) of source ML models that should be selected by the model manager 102. In some aspects, the number may depend on, for example, computational limitations and/or time before the ML model should be deployed.

In some aspects, the process 200 may include a step 202 in which the model manager 102 (e.g., the source model generator 110 of the model manager 102) determines one or more candidate source ML models. In some aspects, determining the one or more candidate source ML models may include selecting from the model store 106 one or more existing source ML models that are suitable for the target based on the information about the task, the information about the input features, the one or more requirements, and/or the number of source ML models received in the request. In some aspects, the candidate source ML model selection may be based on the type of application (e.g., source and target tasks must be relevant to each other), the given performance on source dataset (if available), the model size, and/or the model execution time for inference. In some aspects, determining the one or more candidate source ML models may additionally or alternative include the source model generator 110 creates one or more new source ML models by updating one or more relevant existing source ML models (e.g., replacing neurons or layers with random weights and/or adding/removing neurons/layers). In some aspects, the source model generator 110 may create one or more new source ML models if no existing source ML models in the model store 106 (or not enough source ML models in the model store 106) match the task or the input features of the target task (e.g., heterogeneous transfer learning). In some aspects, the created one or more source ML models may meet the one or more requirements received in the request.

In some aspects, as shown in FIG. 2B, the step 202 may include a sub-step 202a in which the model manager 102 (e.g., the source model generator 110 of the model manager 102) determines whether one or more existing source ML models in the model store 106 meet the one or more requirements received in the request in step 201. In some aspects, if one or more existing source ML models in the model store 106 meet the one or more requirements, the model manager 102 may select one or more existing source ML models that meet the one or more requirements as the one or more candidate source ML models. In some aspects, as shown in FIG. 2B, the step 202 may include a sub-step 202b in which, if no existing source ML models (or an insufficient number of existing source ML models) in the model store 106 meet the one or more requirements, the model manager 102 (e.g., the source model generator 110 of the model manager 102) creates one or more new source ML models to meet the one or more requirements.

In some aspects, the process 200 may include a step 203 in which the model manager 102 (e.g., the model quality evaluator 108 of the model manager 102) assigns a score to the one or more candidate source ML models selected or generated in step 202. In some aspects, the model manager 102 may calculate the assigned score using a predictive model to predict the performance of the ML model using its weights, model quality, and/or other meta data about the source model such as, for example and without limitation, its performance on source dataset, execution time, size, etc. In some alternative aspects, instead of being calculated in step 203, the score(s) for some or all of the one or more candidate source ML models (e.g., one or more existing candidate source ML models selected from the model store 106 in step 202) may be pre-calculated, stored (e.g., in the model store 106), and retrieved.

In some aspects, the process 200 may include a step 204 in which the model manager 102 (e.g., the source model generator 110 of the model manager 102) selects one or more candidate source ML models based on the scores assigned in step 203 or previously assigned (e.g., the model manager 102 may select the one or more candidate source ML models having the top scores). In some aspects, in step 204, the model manager 102 may send the selected one or more candidate source ML models to the target domain 104.

In some aspects, the process 200 may include a step 205 in which the model manager 102 receives a response from the target domain 104. In some aspects, the response may include fine-tuned model weights for the one or more candidate source ML models sent in step 204. In some aspects, the response from the target domain 104 may include additional information such as, for example and without limitation, execution time (of inference).

In some aspects, the process 200 may include a step 206 in which the model manager 102 (e.g., the model quality evaluator 108 of the model manager 102) calculates a score for the one or more fine-tuned ML models.

In some aspects, the process 200 may include a step 207 in which the model manager 102 sends to the target domain 104 a ranked list of one or more fine-tuned ML models based on the calculated scores. In some aspects, if only one candidate source model exists, the model manager 102 may send to the target domain 104 a recommendation (e.g., deploy or not) based on the calculated score.

In some aspects, the process 200 may include an optional step 208 in which the model manager 102 receives feedback from the target domain 104. In some aspects, if one of the top-ranked fine-tuned ML models is selected and deployed by the target domain, the model manager may add the ML model and its metadata metrics to the model store 106.

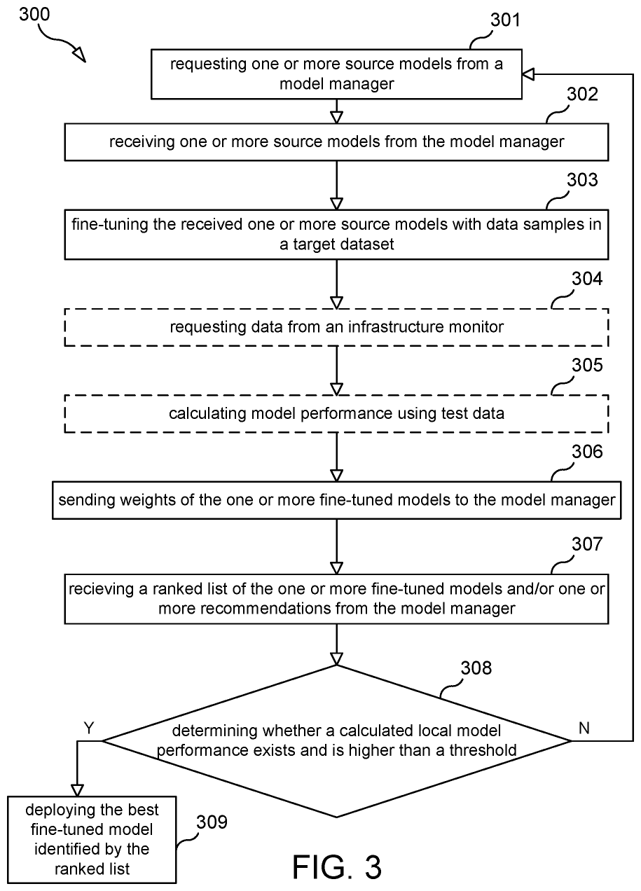

FIG. 3 illustrates a process 300 that may be performed by the target domain 104 according to some aspects. In some aspects, the process 300 may include a step 301 in which the target domain 104 requests one or more source ML models for a task from the ML model manager 102. In some aspects, the request may include information about the task (T_T) and/or the input features (X_T). In some aspects, the request may additionally or alternatively include one or more requirements of the requested one or more source ML models. In some aspects, the one or more requirements may include, for example and without limitation, maximum acceptable model size, and/or required latency for inference. In some aspects, the request may additionally or alternatively include a maximum number and/or a minimum number (e.g., budget) source ML models that are acceptable for fine-tuning.

In some aspects, the process 300 may include a step 302 in which the target domain 104 receives one or more pre-trained source ML models from the model manager 102. In some aspects, in step 302, the target domain 104 may receive information about the task and input features of the received one or more pre-trained source ML models.

In some aspects, the process 300 may include a step 303 in which the target domain 104 (e.g., the target model trainer 112 of the target domain 104) fine-tunes the received one or more source ML models with available data samples in the target dataset 114.

In some aspects, the process 300 may include an optional step 304 in which the target domain 104 requests data from the infrastructure monitor 116 depending on the properties of the source ML models (e.g., execution time or inference latency, computational cost, etc.).

In some aspects, the process 300 may include a step 305 in which the target domain 104 (e.g., the target model trainer 112 of the target domain 104) calculates ML model performance using test data (if test samples exist in the target dataset 114) and/or using cross validation techniques. In some aspects, the target dataset 114 may not include any test samples, and step 305 may be skipped. In some alternative aspects, the target dataset 114 may include a number of test samples that is sufficient and representative enough to allow for a proper evaluation of the fine-tuned ML model or an ML model trained from scratch in the target domain 104, and steps 306 and 307 may be skipped. In some other alternative aspects, the target dataset 114 may include a number of test samples that is insufficient and/or not representative enough to allow for a proper evaluation of the fine-tuned ML model or an ML model trained from scratch in the target domain 104, and the process 300 may proceed to steps 306 and 307.

In some aspects, the process 300 may include a step 306 in which the target domain 104 send the weights of the one or more fine-tuned ML models to the ML model manager 102 for evaluation based on the weights and other target requirements such as, for example and without limitation, latency requirements for model inference, cost of collecting features as inputs to the ML models, execution environmental limitations, etc. In some aspects, in step 306, the target domain 104 may additionally or alternatively send a target ML model trained from scratch (e.g., using data samples in target dataset 114) so that the target ML model can be included in model rankings to avoid negative transfer, which occurs when training from scratch performs better than transferring from irrelevant source ML models.

In some aspects, the process 300 may include a step 307 in which the target domain 104 receives a ranked order of ML models from the model manager 102. In some aspects, in step 307, the target domain 104 may additionally or alternatively receive one or more recommendations (e.g., deploy or not).

In some aspects, the process 300 may include a step 308 in which the target domain 104 determines whether a calculated local model performance (e.g., calculated in step 305 using test samples from the target dataset 114) exists and is higher than a threshold. If not, the process 300 may proceed from step 308 back to step 301 to request one or more new source ML models. If so, the process 300 may proceed from step 308 to a step 309 in which the target domain 104 deploys the best ML model (as identified by the received ranked order of ML models) locally. In some aspects, in step 309, the target domain 104 may optionally send feedback to the model manager 102 about the deployed ML model.

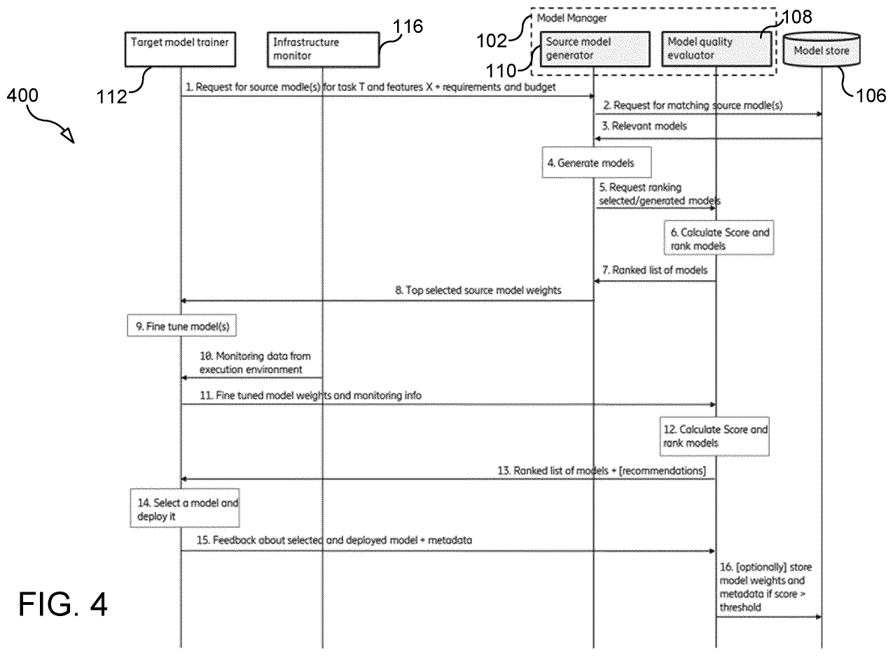

FIG. 4 is a sequence diagram illustrating a process 400 performed by the system 100 according to some aspects. In some aspects, the process 400 may include a step 1 in which the target model trainer 112 of the target domain 104 sends a request for one or more source ML models for a task T. See step 301 of the process 300 in FIG. 3. In some aspects, the step 1 may include the model manager 102 (e.g., the source model generator 110 of the model manager 102) receiving the request. See step 201 of the process 200 in FIGS. 2A and 2B. In some aspects, the request may include information about the task T, information about features X, one or more requirements, and/or a maximum or minimum number (e.g., budget) of source ML models that should be selected.

In some aspects, the process 400 may include a step 2 in which the model manager 102 (e.g., the source model generator 110 of the model manager 102) requests one or more matching source ML models from the model store 106. In some aspects, the process 400 may include a step 3 in which the source model generator 110 receives from the model store 106 one or more relevant source ML models (if any). In some aspects, the process 400 may include a step 4 in which the source model generator 110 creates one or more source ML models. In some aspects, the source model generator 110 may use source models received from the model store 106 in step 3 and/or source models created in step 4 as one or more candidate source ML models. See step 202 of the process 200 in FIG. 2A and steps 202a and 202b of the process 200 in FIG. 2B.

In some aspects, the process 400 may include a step 5 in which the source model generator 110 sends a request to the model quality evaluator 108 for a ranking of the one or more candidate source ML models that were selected and/or created in steps 2-4 of the process 400. In some aspects, the process 400 may include a step 6 in which the model quality evaluator 108 calculates a score for each of the one or more candidate source ML models and ranks the one or more candidate source ML models. In some alternative aspects (e.g., aspects in which one or more candidate source ML models were selected in steps 2 and 3), the source model generator 110 may receive from the model store 106 pre-calculated scores for one or more candidate source ML models (e.g., in step 3) instead of the scores for being calculated in step 6.

In some aspects, the process 400 may include a step 7 in which the model quality evaluator 108 sends and the source model generator 110 receives a ranked list of the one or more candidate source ML models. See step 203 of the process 200 in FIGS. 2A and 2B. In some aspects, the process 400 may include a step 8 in which the source model generator 110 selects one or more of the top-ranked candidate source ML models and sends the selected one or more candidate source ML models (e.g., the model weights of the one or more candidate source ML models), which are received by the target model trainer 112 of the target domain 104. See step 204 of the process 200 in FIGS. 2A and 2B; step 302 of the process 300 in FIG. 3.

In some aspects, the process 400 may include a step 9 in which the target model trainer 112 of the target domain 104 fine-tunes the received one or more source ML models with available data samples in the target dataset 114. See step 303 of the process 300 in FIG. 3.

In some aspects, the process 400 may include a step 10 in which the target model trainer 112 of the target domain 104 requests and receives data from the infrastructure monitor 116 related to the execution environment. See step 304 of the process 300 in FIG. 3.

In some aspects, the process 400 may include a step 11 in which the target model trainer 112 of the target domain 104 sends and the model quality evaluator 108 of the model manager 102 receives weights of the one or more fine-tuned ML models and/or monitoring information. See step 205 of the process 200 in FIGS. 2A and 2B; step 306 of the process 300 in FIG. 3.

In some aspects, the process 400 may include a step 12 in which the model quality evaluator 108 of the model manager 102 calculates a score for and ranks the one or more fine-tuned ML models. See step 206 of the process 200 in FIGS. 2A and 2B. In some aspects, the process 400 may include a step 13 in which the model quality evaluator 108 of the model manager 102 sends and the target model trainer 112 of the target domain 104 receives a ranked list of ML models and/or one or more recommendations (e.g., deploy or not). See step 207 of the process 200 in FIGS. 2A and 2B; step 307 of the process 300 in FIG. 3. In some aspects, the process 400 may include a step 14 in which the target model trainer 112 of the target domain 104 selects and deploys an ML model. See steps 308 and 309 of the process 300 in FIG. 3.

In some aspects, the process 400 may include a step 15 in which the target model trainer 112 of the target domain 104 sends and the model quality evaluator 108 of the model manager 102 receives feedback about the selected and deployed ML model and/or metadata. In some aspects, the process 400 may include a step 16 in which the model quality evaluator 108 of the model manager 102 stores model weights and/or metadata if the score for the selected and deployed ML model is above a threshold. See step 208 of the process 200 in FIGS. 2A and 2B; step 309 of the process 300 in FIG. 3.

### Model Quality Score Calculation

In some aspects (e.g., in step 203 of the process 200), the model manager 102 (e.g., the model quality evaluator 108 of the model manager 102) calculates a score for each of one or more candidate source ML models. In some aspects (e.g., in step 206 of the process 200), the model manager 102 (e.g., the model quality evaluator 108 of the model manager 102) calculates a score for each of one or more fine-tuned ML models (e.g., one or more candidate source models with fine-tuned model weights received from the target domain 104). In some aspects, the model manager 102 may calculate the scores in order to rank the source ML models (e.g., in step 203 of the process 200) or the fine-tuned ML models (e.g., in step 206 of the process 200). In some aspects, the model manager 102 may calculate the scores based on one or a combination of two or more of the following methods.

In some aspects, the model quality score may be based on a model accuracy prediction (Acc) that predicts the accuracy of a neural network (NN) model using its weights. In some aspects, calculating the Acc may use an accuracy predictor model that uses as input features the statistics of NN model weights and as output the accuracy of the NN. See, e.g., Reference 1.

In some aspects, the model quality score may be additionally or alternatively based on one or more model quality metrics (Quality), which may be one or more statistical metrics calculated based on NN model weights that be used to distinguish between well-trained and poorly-trained NN models. In some aspects, the one or more model quality metrics may include norm-based capacity control metrics and/or power-law based metrics. See, e.g., Reference 2.

In some aspects, the model quality score may be additionally or alternatively based on model weight changes (Distance) indicative of how much weights of the model have changed during fine-tuning. In some aspects, the Distance may predict final model performance using model weights during hyperparameter search. The features generated from weight changes may predict of the final model performance during training. See, e.g., Reference 3.

In some aspects, the model quality score may be additionally or alternatively based on model inference cost (Cost). In some aspects, the inference time and the computation cost may be taken into account when assigning a score to rank the models (e.g., if there are computation or latency limitations at the target domain 104). In some aspects, the higher the cost, the lower the score.

In some aspects, the model quality score may be additionally or alternatively based on model meta data (Meta). In some aspects, the model metadata may be related to, for example and without limitation, diversity of source data (see, e.g., Larsson, Hannes, et al., “Source Selection in Transfer Learning for Improved Service Performance Predictions,” 2021 IFIP Networking Conference (IFIP Networking), IEEE, 2021) and/or accuracy on source test data) can also be used in calculation of the score.

In some aspects, to calculate the score a candidate source model Msrc with weight vector Wsrc (e.g., in step 203 of the process 200), the model manager 102 (e.g., the model quality evaluator 108 of the model manager 102) may consider, for example and without limitation, model accuracy prediction, model quality metrics, and/or model inference cost. In some aspects, the score may be calculated as the weighted sum:

$$Score ( {M}_{s r c} ) = {w}_{1} ( {W}_{s r c} ) + {w}_{2} ( {W}_{s r c} ) + {w}_{3} ( 1 - Cost ( {M}_{s r c} ) ) + {w}_{4} Meta ( {M}_{s r c} ) + c$$

where Σwᵢ=1, c is a constant, and all the values are normalized (between 0 and 1).

In some aspects, to calculate the score a fine-tuned model Mu with weight vector Wₜₗ (e.g., in step 206 of the process 200), the model manager 102 (e.g., the model quality evaluator 108 of the model manager 102) may consider, for example and without limitation, model accuracy prediction, model quality metrics, changes in model weights, and/or model inference cost. In some aspects, model weight changes may be obtained by calculating the distance (e.g., 12 distance) of the source model weights and the fine-tuned weights. In some aspects, the score may be calculated as the weighted sum:

$$Score ( {M}_{tl} ) = {w}_{1} ( {W}_{tl} ) + {w}_{2} ( {W}_{src} ) + {w}_{3} ( {W}_{tl} ) + {w}_{4} ( 1 - Cost ( {M}_{tl} ) ) + {w}_{5} ( 1 - Distance ( {W}_{src} , {W}_{tl} ) + c$$

where Σwᵢ=1, c is a constant, and all the values are normalized (between 0 and 1).

In some alternative aspects, the scores for the one or more candidate source models and/or the one or more fine-tuned modes may be calculated in different ways (e.g., as different weighted sums using different combinations of the different functions).

In some aspects, the predictor model, which may be used for estimating model accuracy, may be trained using one or more source models available in the model store 106 (e.g., assuming that the performance of the one or more source models on the source test dataset is known). In some alternative aspects, the predictor model may additionally or alternatively be trained using a dataset of model weights and their performance created using available (e.g., publicly available) datasets. In aspects, the dataset creation and training for Convolutional Neural Networks (CNN) models may be, for example, as explained in Reference 1.

### Generating Source Models

In some aspects (e.g., in step 202 of the process 200), the model manager 102 (e.g., the source model generator 110 of the model manager 102) determines one or more candidate source ML models. In some aspects, determining the one or more candidate source ML models may include the source model generator 110 creating one or more new source ML models by updating one or more relevant existing source ML models (e.g., replacing neurons or layers a neural network of an existing source ML model with random weights and/or adding/removing neurons/layers).

In some aspects (e.g., in the case of heterogeneous transfer learning where the source and the target models have different input features), a new source ML model may be created from existing source ML models. For example, in some aspects, creating a new source ML model may include replacing the first layer of the source ML model with a new layer matching the number of input features from the target domain 104. In some aspects, the weights of the new layer may be randomly initialized. In some aspects, the initialization may be performed using different methods and/or random functions.

In some aspects, the source model generator 110 may create a number of new candidate source ML models and then select the best one based on the score calculated by the model quality evaluator 108. In some aspects, the source generator 110 may create a new source ML model using the weights of other relevant source ML models.

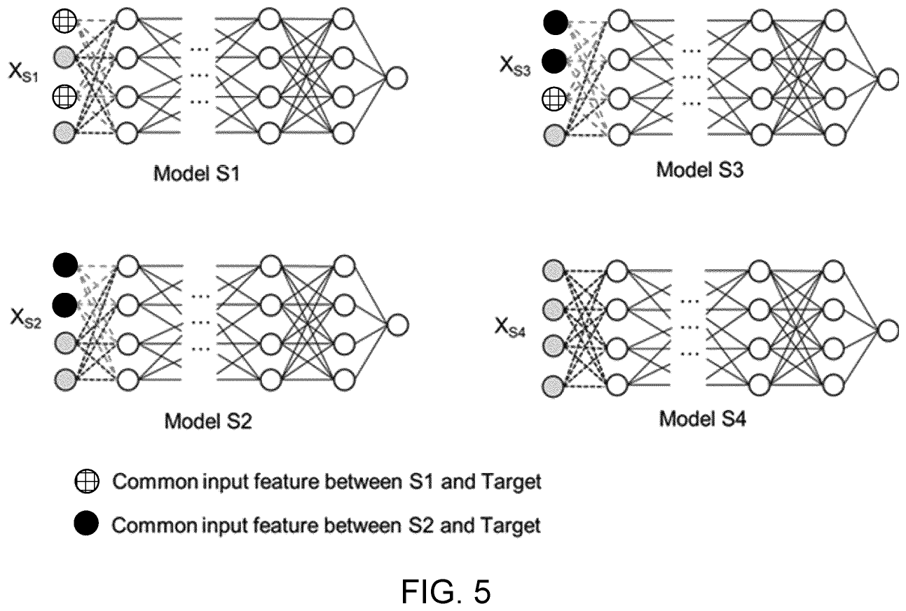

FIG. 5 illustrates an example in which models S1 and S2 each have two common features with the target (shown as cross-hatching and solid input features respectively). In some aspects, the source model generator 110 may update models S1 and S2 by replacing the other weights on the first layer of the neural network with random weights. In some aspects, the source model generator 110 may additionally or alternatively create a new model S3 by combining input features/weights from both S1 and S2 and replacing the rest of the weights on first layer with random weights, and the weights of the rest of the layers may be copied from either S1 or S2. In some aspects, the source model generator 110 may additionally or alternatively create a new model S4 where all weights of the first layer are replaced with random weights. In some aspects, if the task in the target domain 104 is different from the source model, then source model generator 110 may additionally or alternatively replace the last layer of the neural network of the source model with a new layer and random weights. In some aspects, the model quality evaluator 108 may evaluate and rank the new models (e.g., the updated models S1 and S2 and the models S3 and S4) created by the source model generator 110.

In some aspects, the source model generator 110 may create one or more source ML models by augmenting one or more source models using one or more model quality scores calculated by the model quality evaluator 108. In some aspects, the model quality evaluator 108 may calculate the scores in any of the manners described above. In some aspects, the source model generator 110 may create a source ML model by updating the model weights so that the score of the model is improved.

In some aspects, the source model generator 110 may create one or more source ML models by using generative methods. For example, in some aspects, the source model generator 110 may use a generator neural network (e.g., the generator neural network presented in Lior Deutsch, “Generating neural networks with neural networks” (available https://arxiv.org/abs/1801.01952, 2018)) to generate accurate and diverse neural networks. In some aspects, after the source model generator 110 generates a number of candidate source models, the model quality evaluator 108 may calculate a score to rank the generated models.

### Use Cases

Aspects of the invention may be used for many different use cases. For example, aspects of the invention may be used when a set of network services is deployed in Edge/Cloud/Datacenters. Predicting the service quality, for example using machine-learning models, may be useful for service assurance, service onboarding, and/or troubleshooting. Such execution environments may be dynamic, and containers or virtual machines (VMs) which are hosting the applications or Virtual Network Functions (VNFs) may be dynamically scaled up/down or migrated. These changes impact the performance of the machine learning (ML) models deployed to, for example, predict the service's key performance indicators (KPIs) or Service Level Agreement (SLA) violations. In some aspects, transfer learning may be used to quickly adapt the ML models to the changed environment. In some aspects, ML models that are trained for different services, in different execution environments, and/or under different workloads may be stored for future use. Aspects of the invention may be used to select the best ML model to be reused (e.g., transferred from a source domain to a target domain). Aspects of the invention may be used to select a suitable source ML model without a need to store the data used for training or evaluation of the source ML models or a need to collect excessive data in the target for test and evaluation purpose.

Some aspects of the invention may be used, for example, for prediction of read/write rates of a database or key-value store service running in a data center (DC), as experienced on the client side, using input features from the Cloud/DC infrastructure such as, for example and without limitation, (CPU usage, memory usage, latency, and/or bandwidth). Collection of infrastructure features and service performance can be costly and time consuming. In some aspects, instead of training and deploying a model from scratch, the target domain 104 may request a pre-trained source model from the model manager 102. In some aspects, the model manager 104 may be used to select the top source/fine-tuned ML model for this particular task/domain. In some aspects, the target domain 104 may then deploy the selected model locally in its execution environment for inference and to predict the performance of the database service and taking actions based on the output. One possible action would be to scale up the service (e.g., the resources in the DC) if the predicted service performance does not conform to the SLAs. The scale up action may impact the execution environment and the service performance, which in turn might trigger the need to deployment of an updated ML model which may require selection and fine-tuning of a different source model.

Some aspects of the invention may be used, for example, ML models trained on data from base stations for different use-cases such as, for example and without limitation, KPI degradation prediction, energy consumption prediction, handover prediction, etc, using performance measurement counters and configuration attributes (e.g., collected from base stations) as input features.

Some aspects of the invention may be used, for example, for Internet of things (IoT) applications. Many IoT devices may have limited computation resources to be able to train and evaluate a high-performance ML model from scratch locally. Additionally, IoT devices may be very constrained with respect to storage and, therefore, storing a large volume of data for proper training and evaluation of a model (even if small) may be prohibited. In some aspects, using transfer learning and only fine-tuning some/all of a model weights may be very helpful in improving the accuracy of the model without a need to store large volume of data or have high computational capacity either for training or testing the model.

In some aspects, because the data from the source domain that was used for training or evaluation of the source ML model is not needed, models that were trained on data from different domains may still be re-used without compromising the data privacy. For example, in some aspects, source ML models trained on data from different operators, or data from the same operator but in different geographical locations where data should not be moved from due to privacy and security concerns may be re-used. For another example, some aspects of the invention may be used for IoT use-cases where the raw data cannot be stored on the IoT device (due to storage limitations) and cannot be transferred to a centralized location (due to privacy concerns), and the model weights can be stored for re-use. In some aspects, more and more source ML models may be added to the model store 106 without any concerns related to storage limitations and communication cost of data transmission. In some aspects, with more models to choose from, selection of the best source ML model to achieve positive transfer gain may become more important.

### Flowcharts

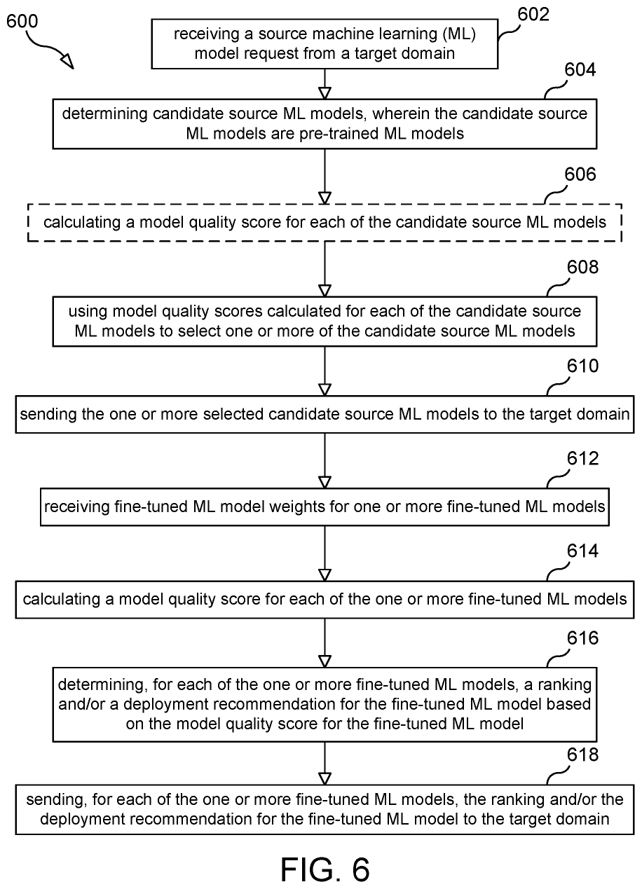

FIG. 6 illustrates a computer-implemented process 600 according to some aspects. In some aspects, one or more steps of the process 600 may be performed by the ML model manager 102.

In some aspects, as shown in FIG. 6, the process 600 may include a step 602 in which the ML model manager 102 receives a source ML model request from a target domain 104. In some aspects, the source ML model request received in step 602 may include information about a task, information about one or more input features, and/or one or more requirements. In some aspects, the source ML model request received in step 602 may additionally or alternatively include one or more requirements, and the one or more requirements may include a maximum model size, a required performance, and/or inference time requirements. In some aspects, the source ML model request received in step 602 may additionally or alternatively include a number of candidate source ML models for the model manager to select, and using the model quality score to select one or more of the candidate source ML models may include selecting the number of candidate source ML models.

In some aspects, as shown in FIG. 6, the process 600 may include a step 604 in which the ML model manager 102 determines candidate source ML models. In some aspects, the candidate source ML models may be pre-trained ML models.

In some aspects, determining the candidate source ML models in step 604 may include selecting one or more existing source ML models from a model store 106. In some aspects, the one or more existing source ML models may be selected from the model store 106 based on information about a task, information about one or more input features, and/or one or more requirements included in the source ML model request.

In some aspects, determining the candidate source ML models in step 604 may additionally or alternatively include creating one or more new source ML models. In some aspects, creating the one or more new source ML models in step 604 may include updating one or more existing source ML models from a model store 106. In some aspects, updating the one or more existing source ML models may include replacing neurons and/or layers of neural networks of the one or more existing source ML models with random weights and/or adding or removing neurons and/or layers to or from the one or more existing source ML models. In some aspects, for each of the one or more updated source ML models, a model quality score for the updated source ML model may be improved relative to a model quality score for an existing source ML model on which the updated source ML model is based.

In some aspects, determining the candidate source ML models in step 604 may include determining that no existing source ML models or an insufficient number of existing source ML models from a model store 106 match information about a task, information about one or more input features, and/or one or more requirements included in the source ML model request.

In some aspects, creating the one or more new source ML models in step 604 may include: creating new source ML models, calculating a model quality score for each of the new source ML models, and/or using the model quality score calculated for the new source ML models to select one or more of the new source ML models. In some aspects, the one or more new source ML models may be created using parameters of one or more existing source ML models from a model store. In some aspects, creating the one or more new source ML models may include using one or more generative ML methods.

In some aspects, as shown in FIG. 6, the process 600 may include an optional step 606 in which the ML model manager 102 calculates a model quality score for each of the candidate source ML models. In some alternative aspects, the model quality score for one or more of the candidate source ML models (e.g., one or more existing source ML models selected from the model store 106) may be pre-calculated, stored in the model store 106, and received from the model store 106 (e.g., in step 604). In some aspects, the model quality score for each of the candidate source ML models may be calculated using a predictive model to predict the performance of a candidate source ML model using parameters of the candidate source ML model, model quality, and/or metadata about the candidate source ML model (e.g., source dataset, execution time, and/or size).

In some aspects, the model quality score for each of the candidate source ML models may additionally or alternatively be calculated based on (i) a model accuracy prediction (Acc) that predicts accuracy using parameters of a candidate source ML model, (ii) one or more model quality metrics (Quality) calculated using parameters of the candidate source ML model, (iii) a model inference cost (Cost) indicative of inference time and/or computation cost for the candidate source ML model, and/or (iv) model metadata (Meta) related to diversity of source data and/or accuracy on source test data). In some aspects, the model quality score for a candidate source ML model Msrc with a weight vector Wsrc may be, for example and without limitation, a weighted sum:

$$Score ( {M}_{src} ) = {w}_{1} ( {W}_{src} ) + {W}_{2} ( {W}_{src} ) + {w}_{3} ( 1 - Cost ( {M}_{src} ) ) + {w}_{4} Meta ( {M}_{src} ) + c$$

where Σwᵢ=1, c is a constant, and all values are normalized.

In some aspects, as shown in FIG. 6, the process 600 may include a step 608 in which the ML model manager 102 uses model quality scores calculated for each of the candidate source ML models to select one or more of the candidate source ML models.

In some aspects, as shown in FIG. 6, the process 600 may include a step 610 in which the ML model manager 102 sends the one or more selected candidate source ML models to the target domain 104.

In some aspects, as shown in FIG. 6, the process 600 may include a step 612 in which the ML model manager 102 receives fine-tuned ML model weights for one or more fine-tuned ML models (e.g., fine-tuned ML model weights for the one or more selected candidate source ML models). In some aspects, calculating the model quality score for each of the one or more fine-tuned ML models in step 612 may include using a predictive model to predict the performance of a fine-tuned ML model using weights of the fine-tuned ML model, model quality, changes in weights of the fine-tuned ML model relative to weights of a source ML model on which the fine-tuned ML model is based, and/or metadata about the fine-tuned ML model (e.g., source dataset, execution time, and/or size). In some aspects, the model quality score for each of the one or more fine-tuned ML models may be based on model accuracy prediction, model quality, changes in weights of the fine-tuned ML model relative to weights of a source ML model on which the fine-tuned ML model is based, and/or inference cost.

In some aspects, calculating the model quality score in step 612 may be based on (i) a model accuracy prediction (Acc) that predicts accuracy using weights of a fine-tuned ML model, (ii) one or more model quality metrics (Quality) calculated using weights of the fine-tuned ML model, (iii) model weight changes (Distance) indicative of how much weights of the model have changed during fine-tuning, (iv) a model inference cost (Cost) indicative of inference time and/or computation cost for the fine-tuned ML model, and/or (iv) model metadata (Meta) related to diversity of source data and/or accuracy on source test data). In some aspects, the model quality score for a fine-tuned ML model Mft with a weight vector Wsrc based on a candidate source ML model Msrc with a weight vector Wsrc may be, for example and without limitation, a weighted sum:

$$Score ( {M}_{src} ) = {w}_{1} ( {W}_{src} ) + {w}_{2} ( {W}_{src} ) + {w}_{3} ( 1 - Cost ( {M}_{src} ) ) + {w}_{4} Meta ( {M}_{src} ) + c$$

where Σwᵢ=1, c is a constant, and all values are normalized.

In some aspects, as shown in FIG. 6, the process 600 may include a step 614 in which the ML model manager 102 calculates a model quality score for each of the one or more fine-tuned ML models.

In some aspects, as shown in FIG. 6, the process 600 may include a step 616 in which the ML model manager 102 determines, for each of the one or more fine-tuned ML models, a ranking and/or a deployment recommendation for the fine-tuned ML model based on the model quality score for the fine-tuned ML model.

In some aspects, as shown in FIG. 6, the process 600 may include a step 618 in which the ML model manager 102 sends, for each of the one or more fine-tuned ML models, the ranking and/or the deployment recommendation for the fine-tuned ML model to the target domain 104.

In some aspects, the process 600 may further include an optional step in which the ML model manager 102 receives feedback from the target domain identifying a deployed fine-tuned ML model. In some aspects, the process 600 may further include an optional step in which the ML model manager 102 adds the deployed fine-tuned ML model and/or metadata for the deployed fine-tuned ML model to the model store 106.

In some aspects, the process 600 may further include an optional step in which the ML model manager 102 receives a target model trained solely using data samples in a target dataset of the target domain 104, calculates a model quality score for the target model, determining a ranking for the target model based on the model quality score for the target model, and/or sending the ranking for the target model to the target domain 104.

In some aspects, each of the one or more selected candidate source ML models may be pre-trained using data for a network service in an execution environment with a workload, and the one or more fine-tuned ML models may be the one or more selected candidate source ML models after being fine-tuned for a different network service, a different execution environment, and/or a different workload. In some alternative aspects, each of the one or more selected candidate source ML models may be pre-trained using data for an Internet of things (IoT) device in an environment, and the one or more fine-tuned ML models may be the one or more selected candidate source ML models after being fine-tuned for a different IoT device and/or a different environment. In some aspects, the candidate source ML models may be for network performance prediction, key performance indicator (KPI) prediction, base station energy consumption prediction, Internet of things (IoT) traffic pattern classification, or manufacturing product quality inspection.

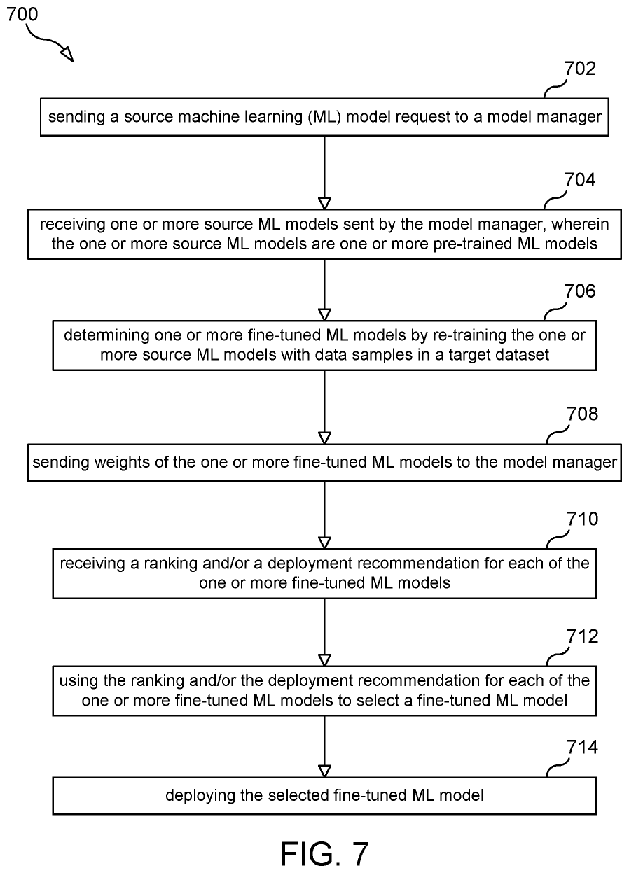

FIG. 7 illustrates a computer-implemented process 700 according to some aspects. In some aspects, one or more steps of the process 700 may be performed by the target domain 104.

In some aspects, as shown in FIG. 7, the process 700 may include a step 702 in which the target domain 104 sends a source machine learning (ML) model request to a model manager 102. In some aspects, the source ML model request sent in step 702 may include information about a task, information about one or more input features, and/or one or more requirements. In some aspects, the source ML model request sent in step 702 may additionally or alternatively include one or more requirements, and the one or more requirements may include a maximum model size, a required performance, and/or inference time requirements. In some aspects, the source ML model request sent in step 702 may additionally or alternatively include a number of source ML models for the model manager 102 to select, and receiving the one or more source ML models may include receiving the number of candidate source ML models.

In some aspects, as shown in FIG. 7, the process 700 may include a step 704 in which the target domain 104 receives one or more source ML models from the model manager 102. In some aspects, the one or more source ML models may be one or more pre-trained ML models. In some aspects, the step 704 may further include receiving, for each of the one or more source ML models, information about a task and/or input features of the source ML model.

In some aspects, as shown in FIG. 7, the process 700 may include a step 706 in which the target domain 104 determines one or more fine-tuned ML models by re-training the one or more source ML models with data samples in a target dataset 114.

In some aspects, as shown in FIG. 7, the process 700 may include a step 708 in which the target domain 104 sends weights of the one or more fine-tuned ML models to the model manager 102.

In some aspects, the process 700 may include an optional step in which the target domain 104 requests monitoring information from an infrastructure monitor 116 and sends the monitoring information to the model manager 102. In some aspects, the process 700 may additionally or alternatively include an optional step in which the target domain 104 uses test samples from a target dataset 114 to calculate model performance for the one or more fine-tuned ML models. In some aspects, the process 700 may additionally or alternatively include an optional step in which the target domain 104 sends a target model trained solely using data samples in a target dataset 114 to the model manager 102.

In some aspects, as shown in FIG. 7, the process 700 may include a step 710 in which the target domain 104 receives a ranking and/or a deployment recommendation for each of the one or more fine-tuned ML models.

In some aspects, as shown in FIG. 7, the process 700 may include a step 712 in which the target domain 104 uses the ranking and/or the deployment recommendation for each of the one or more fine-tuned ML models to select a fine-tuned ML model.

In some aspects, as shown in FIG. 7, the process 700 may include a step 712 in which the target domain 104 deploys the selected fine-tuned ML model. In some aspects, deploying the selected fine-tuned ML model in step 712 may include, for example and without limitation, using the selected fine-tuned ML model for network performance prediction, key performance indicator (KPI) prediction, base station energy consumption prediction, Internet of things (IoT) traffic pattern classification, or manufacturing product quality inspection.

In some aspects, the process 700 may further include an optional step in which the target domain 104 sends feedback to the model manager 102 identifying the deployed fine-tuned ML model.

In some aspects, each of the one or more source ML models may be pre-trained using data for a network service in an execution environment with a workload, and the one or more fine-tuned ML models may be the one or more source ML models after being fine-tuned for a different network service, a different execution environment, and/or a different workload. In some alternative aspects, each of the one or more source ML models may be pre-trained using data for an Internet of things (IoT) device in an environment, and the one or more fine-tuned ML models may be the one or more source ML models after being fine-tuned for a different IoT device and/or a different environment.

### Block Diagrams

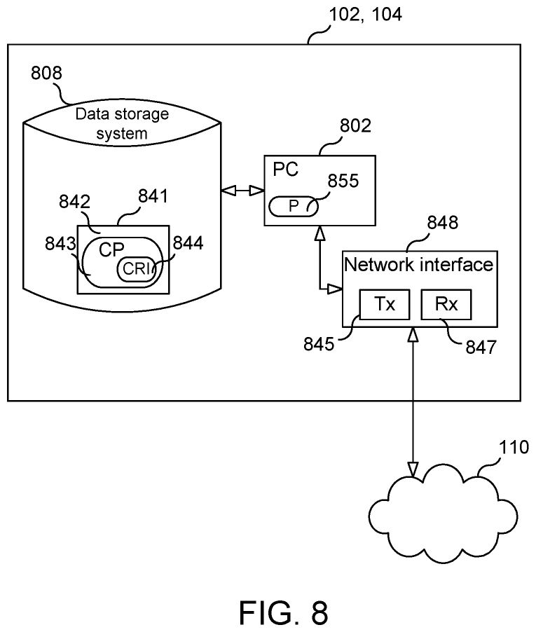

FIG. 8 is a block diagram of an apparatus (e.g., model manager 102 or target domain 104), according to some aspects. As shown in FIG. 8, apparatus 102 or 104 may include: processing circuitry (PC) 802, which may include one or more processors (P) 855 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 102 or 104 may be a distributed computing apparatus); at least one network interface 848 comprising a transmitter (Tx) 845 and a receiver (Rx) 847 for enabling apparatus 102 or 104 to transmit data to and receive data from other nodes connected to a network 110 (e.g., an Internet Protocol (IP) network) to which network interface 848 is connected (directly or indirectly) (e.g., network interface 848 may be wirelessly connected to the network 110, in which case network interface 848 is connected to an antenna arrangement); and a storage unit (a.k.a., “data storage system”) 808, which may include one or more non-volatile storage devices and/or one or more volatile storage devices. In some alternative aspects, network interface 848 may be connected to the network 110 over a wired connection, for example over an optical fiber or a copper cable. In some aspects where PC 802 includes a programmable processor, a computer program product (CPP) 841 may be provided. CPP 841 includes a computer readable medium (CRM) 842 storing a computer program (CP) 843 comprising computer readable instructions (CRI) 844. CRM 842 may be a non-transitory computer readable medium, such as, magnetic media (e.g., a hard disk), optical media, memory devices (e.g., random access memory, flash memory), and the like. In some aspects, the CRI 844 of computer program 843 is configured such that when executed by PC 802, the CRI causes apparatus 102 or 104 to perform steps of the methods described herein (e.g., steps described herein with reference to one or more of the flow charts). In some other aspects, an apparatus 102 or 104 may be configured to perform steps of the methods described herein without the need for code. That is, for example, PC 802 may consist merely of one or more ASICs. Hence, the features of the aspects described herein may be implemented in hardware and/or software.

### Evaluation Results

Aspects of the invention have been applied for calculation of a model score on datasets from six different domains with different data distribution. The datasets include performance monitor (PM) data collected from multiple base stations from each domain, and the task is key performance indicator (KPI) prediction.

The data from two of the operators was used to create a dataset of different neural networks and their accuracy was used to train a random forest model for predicting the accuracy of the neural network models using statistics of their weights as input features. The data from the other four domains have been used to train different source models using different number of samples to populate the Model store with both well-trained and poorly-trained source models.

For each transfer learning experiment, we randomly selected 100 samples from each operator dataset and calculated a model quality score for all the source models to perform a full comparison of all the source models. The model quality score was calculated as:

$$0.4 * ( {W}_{src} ) + 0.5 * ( {W}_{tl} ) + 0.1 * ( 1 - Distance ( {W}_{src} , {W}_{tl} ) )$$

where the accuracy and distance values are normalized using min max normalization. The selection of the values for wᵢ here was performed empirically. The predicted accuracy of the source and the fine-tuned model was observed to play a significant role in quantifying the quality of the model. One can also train an ML model to learn these values so that they can generalize if some ground truth data exists.

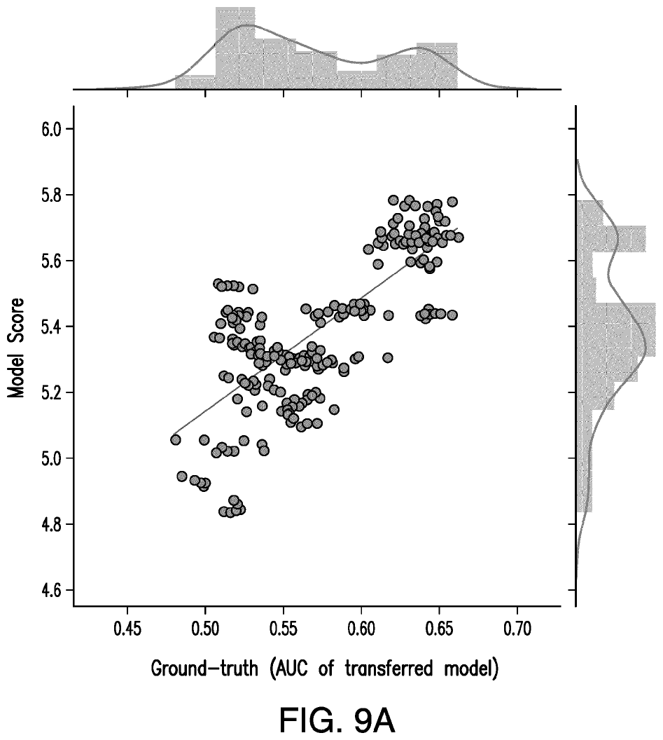

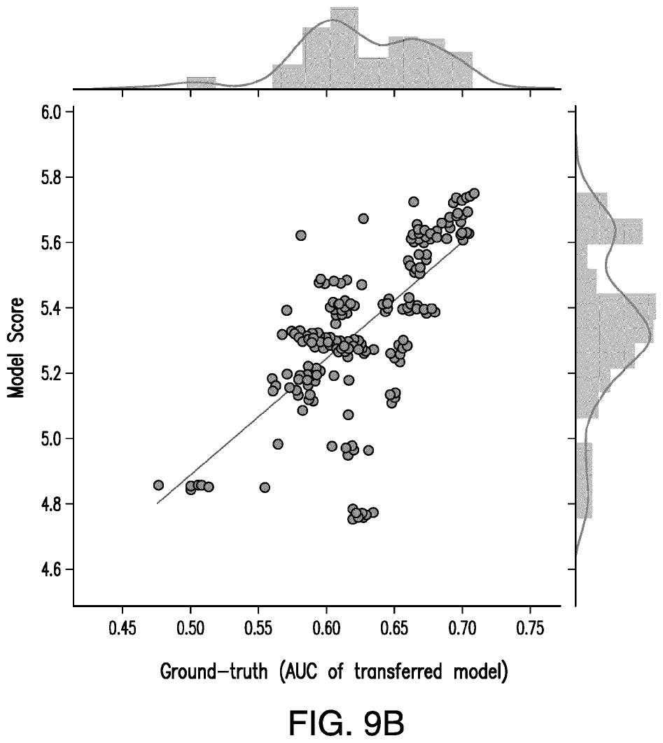

FIGS. 9A and 9B show the evaluation results for two transfer learning (TL) scenarios. The transferred models that achieved the highest performance in the target (based on the Area Under the Curve (AUC) score calculated on test data as the ground truth) have also been assigned a high model quality score compared to the other models. These results confirm the feasibility of selecting good source models with only using features extracted from model parameters (weights).

In some aspects, the model manager 102 and its components (e.g., the model store 106, model quality evaluator 108, and/or source model generator 110) may be executed in a cloud environment. In some aspects, the target domain 104 and its components (e.g., the target model trainer 112, target dataset 114, and/or infrastructure monitor 116) may be executed in a cloud environment.

While various aspects are described herein, it should be understood that they have been presented by way of example only, and not limitation. Thus, the breadth and scope of this disclosure should not be limited by any of the above-described exemplary aspects. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A computer-implemented method performed by a machine learning (ML) model manager, the method comprising:
receiving a source ML model request from a target domain;
determining candidate source ML models, wherein the candidate source ML models are pre-trained ML models;
using model quality scores calculated for each of the candidate source ML models to select one or more of the candidate source ML models;
sending the one or more selected candidate source ML models to the target domain;
receiving fine-tuned ML model weights for one or more fine-tuned ML models;
calculating a model quality score for each of the one or more fine-tuned ML models:
determining, for each of the one or more fine-tuned ML models, a ranking and/or a deployment recommendation for the fine-tuned ML model based on the model quality score for the fine-tuned ML model; and
sending, for each of the one or more fine-tuned ML models, the ranking and/or the deployment recommendation for the fine-tuned ML model to the target domain.

2. The method of claim 1, wherein determining the candidate source ML models comprises selecting one or more existing source ML models from a model store.

3. The method of claim 1, wherein determining the candidate source ML models comprises creating one or more new source ML models.

4-6. (canceled)

7. The method of claim 1, wherein the model quality score for each of the candidate source ML models is calculated using a predictive model to predict the performance of a candidate source ML model using parameters of the candidate source ML model, model quality, and/or metadata about the candidate source ML model.

8. The method of claim 1, wherein the model quality score for each of the candidate source ML models is calculated based on (i) a model accuracy prediction (Acc) that predicts accuracy using parameters of a candidate source ML model, (ii) one or more model quality metrics (Quality) calculated using parameters of the candidate source ML model, (iii) a model inference cost (Cost) indicative of inference time and/or computation cost for the candidate source ML model, and/or (iv) model metadata (Meta) related to diversity of source data and/or accuracy on source test data).

9. The method of claim 1, wherein calculating the model quality score for each of the one or more fine-tuned ML models comprises using a predictive model to predict the performance of a fine-tuned ML model using weights of the fine-tuned ML model, model quality, changes in weights of the fine-tuned ML model relative to weights of a source ML model on which the fine-tuned ML model is based, and/or metadata about the fine-tuned ML model.

10. The method of claim 1, wherein the model quality score for each of the one or more fine-tuned ML models is based on model accuracy prediction, model quality, changes in weights of the fine-tuned ML model relative to weights of a source ML model on which the fine-tuned ML model is based, and/or inference cost.

11. The method of claim 1, wherein calculating the model quality score for each of the one or more fine-tuned ML models is based on (i) a model accuracy prediction (Acc) that predicts accuracy using weights of a fine-tuned ML model, (ii) one or more model quality metrics (Quality) calculated using weights of the fine-tuned ML model, (iii) model weight changes (Distance) indicative of how much weights of the model have changed during fine-tuning, (iv) a model inference cost (Cost) indicative of inference time and/or computation cost for the fine-tuned ML model, and/or (v) model metadata (Meta) related to diversity of source data and/or accuracy on source test data.

12. The method of claim 1, further comprising:
receiving feedback from the target domain identifying a deployed fine-tuned ML model; and
adding the deployed fine-tuned ML model and/or metadata for the deployed fine-tuned ML model to a model store.

13. The method of claim 1, further comprising:
receiving a target model trained solely using data samples in a target dataset of the target domain;
calculating a model quality score for the target model:
determining a ranking for the target model based on the model quality score for the target model; and
sending the ranking for the target model to the target domain.

14. The method of claim 1, wherein each of the one or more selected candidate source ML models are pre-trained using data for a network service in an execution environment with a workload, and the one or more fine-tuned ML models are the one or more selected candidate source ML models after being fine-tuned for a different network service, a different execution environment, and/or a different workload.

15. The method of claim 1, wherein each of the one or more selected candidate source ML models are pre-trained using data for an Internet of things (IoT) device in an environment, and the one or more fine-tuned ML models are the one or more selected candidate source ML models after being fine-tuned for a different IoT device and/or a different environment.

16. The method of claim 1, wherein the candidate source ML models are for network performance prediction, key performance indicator (KPI) prediction, base station energy consumption prediction, Internet of things (IoT) traffic pattern classification, or manufacturing product quality inspection.

17. A machine learning (ML) model manager configured to:
receive a source ML model request from a target domain;
determine candidate source ML models, wherein the candidate source ML models are pre-trained ML models;
use model quality scores calculated for each of the candidate source ML models to select one or more of the candidate source ML models;
send the one or more selected source ML models to the target domain;
receive fine-tuned ML model weights for one or more fine-tuned ML models;
calculate a model quality score for each of the one or more fine-tuned ML models;
determine, for each of the one or more fine-tuned ML models, a ranking and/or a deployment recommendation for the fine-tuned ML model based on the model quality score for the fine-tuned ML model; and
send, for each of the one or more fine-tuned ML models, the ranking and/or the deployment recommendation for the fine-tuned ML model to the target domain.

18. A computer-implemented method performed by a target domain, the method comprising:
sending a source machine learning (ML) model request to a model manager;
receiving one or more source ML models from the model manager, wherein the one or more source ML models are one or more pre-trained ML models;
determining one or more fine-tuned ML models by re-training the one or more source ML models with data samples in a target dataset:
sending weights of the one or more fine-tuned ML models to the model manager:
receiving a ranking and/or a deployment recommendation for each of the one or more fine-tuned ML models;
using the ranking and/or the deployment recommendation for each of the one or more fine-tuned ML models to select a fine-tuned ML model; and
deploying the selected fine-tuned ML model.

19-22. (canceled)

23. The method of claim 18, wherein each of the one or more source ML models are pre-trained using data for a network service in an execution environment with a workload, and the one or more fine-tuned ML models are the one or more source ML models after being fine-tuned for a different network service, a different execution environment, and/or a different workload.

24. The method of claim 18, wherein each of the one or more source ML models are pre-trained using data for an Internet of things (IoT) device in an environment, and the one or more fine-tuned ML models are the one or more source ML models after being fine-tuned for a different IoT device and/or a different environment.

25. A target domain configured to:
send a source machine learning (ML) model request to a model manager;
receive one or more source ML models from the model manager, wherein the one or more source ML models are one or more pre-trained ML models;
determine one or more fine-tuned ML models by re-training the one or more source ML models with data samples in a target dataset;
send weights of the one or more fine-tuned ML models to the model manager:
receive a ranking and/or a deployment recommendation for each of the one or more fine-tuned ML models;
use the ranking and/or the deployment recommendation for each of the one or more fine-tuned ML models to select a fine-tuned ML model; and
deploy the selected fine-tuned ML model.

26. The ML model manager of claim 17, comprising:
processing circuitry; and
a memory containing instructions executable by said processing circuitry, whereby said ML model manager is operative to receive the source ML model request, determine the candidate source ML models, select the one or more of the candidate source ML models, send the one or more selected source ML models, receive the fine-tuned ML model weights, calculate the model quality score for each of the one or more fine-tuned ML models, determine the ranking and/or the deployment recommendation for each of the one or more fine-tuned ML models, and sending the ranking and/or the deployment recommendation for each of the one or more fine-tuned ML models.

27. The target domain of claim 25, comprising:
processing circuitry; and
a memory containing instructions executable by said processing circuitry, whereby said target domain is operative to send the source ML model request, receive the one or more source ML models, determine the one or more fine-tuned ML models, send the weights of the one or more fine-tuned ML models, receive the ranking and/or the deployment recommendation for each of the one or more fine-tuned ML models, select the fine-tuned ML model, and deploy the selected fine-tuned ML model.
